(19) United States
(12) Patent Application Publication
(10) Pub. No.: US 2005/0243185 A1
(43) Pub. Date: Nov. 3, 2005

(54) Method for controlling digital photographing apparatus, and digital photographing apparatus using the method

(75) Inventors: Hyuk-soo Son, Seongnam-si (KR); Hong-ju Kim, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/072,172

(22) Filed: Mar. 3, 2005

(30) Foreign Application Priority Data
May 3, 2004 (KR) 10-2004-0030927

(51) Int. Cl. H04N 5/228

(52) U.S. Cl. 348/222.1

(57) ABSTRACT

Provided is a method of controlling a digital photographing apparatus storing an image file in a storage medium of a subject photographed in a photographing mode, reproducing and displaying the image file on a display panel in a reproducing mode, and changing or loading photographing information of the image file needed for the photographing mode in a user setting mode. The method includes storing image data of the image file together with the photographing information of the image file in a change routine for changing the photographing information; and displaying an image of the image data stored in the change routine together with the photographing information on the display panel.

### BACKGROUND OF THE INVENTION

This application claims the priority of Korean Patent Application No. 10-2004-0030927, filed on May 3, 2004, in the Korean Intellectual Property Office, the disclosure of which is incorporated herein in its entirety by reference.

1. Field of the Invention

The present invention relates to a method for controlling a digital photographing apparatus and a digital photographing apparatus using the method. More particularly, the present invention relates to a method for controlling a digital photographing apparatus that stores an image file in a storage medium of a subject photographed in a photographing mode, reproduces and displays the image file on a display panel in a reproducing mode, and changes or loads photographing information of the image file needed for the photographing mode in a user setting mode, and a digital photographing apparatus using the method.

2. Description of the Related Art

A conventional digital photographing apparatus disclosed in U.S. Pat. No. 5,416,556, “Custom Mode Control Apparatus in Camera,” and in Japanese Patent Publication No. 254,837, “Custom Mode Control Device for Camera,” 1992, includes a storage medium and a display panel. Image data obtained in a photographing mode of the digital photographing apparatus is stored in the storage medium. In a reproducing mode, an image selected by a user is displayed on the display panel. In a user setting mode, photographing information needed for the photographing mode is changed or loaded.

The user setting mode of the digital photographing apparatus denotes a mode in which the user stores frequently used photographing information in advance to reuse the photographing information later as a photographing condition.

By using the disclosed conventional digital photographing apparatus, current photographing information can be stored in an area of a user setting item in the photographing mode. Then the stored photographing information, upon selection by the user, can be loaded and used again as a photographing condition. However, since only the photographing information is stored when setting the photographing information, only the photographing information is displayed when it is loaded later. Accordingly, as time passes, the user has difficulty identifying stored photographing conditions based on the text-based photographing information alone.

### SUMMARY OF THE INVENTION

Various embodiments of the present invention provide a method for controlling a digital photographing apparatus and a digital photographing apparatus using the method. The method enables a user to immediately identify what photographing condition the user stored even long after the user stored the photographing condition and also allows the user to determine whether to reuse the photographing condition.

According to an embodiment of the present invention, there is provided a method of controlling a digital photographing apparatus storing an image file in a storage medium of a subject photographed in a photographing mode, reproducing and displaying the image file on a display panel in a reproducing mode, and changing or loading photographing information of the image file needed for the photographing mode in a user setting mode. The method includes (1) storing image data of an image together with the photographing information of the image by using a change routine for changing the photographing information; and (2) displaying on the display panel both the image stored using the change routine together and the photographing information of the image.

According to the method, an image of image comprised data stored during a change routine of a user setting mode is displayed in a loading routine of the user setting mode. Accordingly, even long after a user stored a photographing condition in the change routine of the user setting mode, the user can immediately identify what photographing condition the user stored and determine whether the photographing condition can be reused.

According to another embodiment of the present invention, there is provided a digital photographing apparatus using the controlling method.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating the front and the top of a digital camera according to an embodiment of the present invention;

FIG. 2 is a perspective view illustrating the back and the top of the digital camera of FIG. 1;

FIG. 3 is a schematic diagram of the configuration of the digital camera of FIG. 1;

FIG. 4 is a flowchart illustrating a main program of a digital signal processor (DSP) illustrated in FIG. 3;

FIG. 5 is a flowchart illustrating an embodiment of the photographing program of FIG. 4;

FIG. 6 is a flowchart illustrating an embodiment of the user setting routine program of FIG. 5;

FIG. 7 illustrates a screen displayed on a color LCD panel as a result of performing operation S61 of FIG. 6, according to an embodiment of the present invention;

FIG. 8 illustrates a screen displayed on the color LCD panel when a loading routine is selected as a result of performing operation S63 of FIG. 6, according to an embodiment of the present invention;

FIG. 9 illustrates a screen displayed on the color LCD panel when a change routine is selected as a result of performing operation S63 of FIG. 6, according to an embodiment of the present invention;

FIG. 10 is a flowchart illustrating an embodiment of the change routine program of FIG. 6;

FIG. 11 illustrates a screen displayed on the color LCD panel as a result of performing operation 6606 of FIG. 10, according to an embodiment of the present invention;

FIG. 12 is a flowchart illustrating an embodiment of the loading routine of FIG. 6; and

FIG. 13 illustrates a screen displayed on the color LCD panel as a result of performing operation 6706 of FIG. 12, according to an embodiment of the present invention.

### DETAILED DESCRIPTION OF THE INVENTION

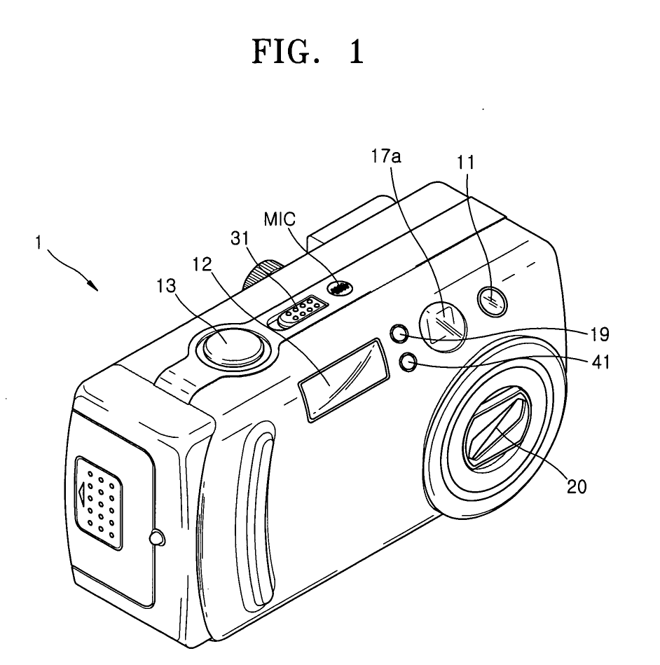

Referring to FIG. 1, the front part of a digital camera 1 according to an embodiment of the present invention includes a microphone MIC, a self-timer lamp 11, a flash 12, a shutter button 13, a viewfinder 17a, a flash light intensity sensor 19, a power switch 31, a lens unit 20, and a remote receiver 41.

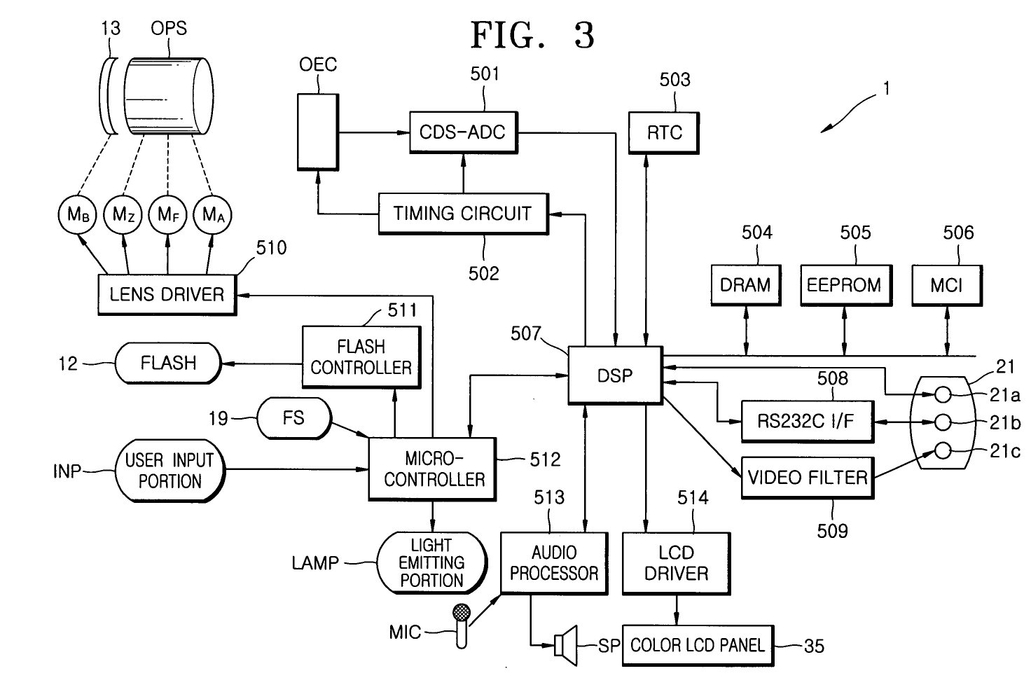

In a self-timer mode, the self-timer lamp 11 operates for a set period of time from the time when the shutter button 13 is pressed to the time when a shutter operates. When the flash 12 operates, the flash light intensity sensor 19 senses the intensity of the light generated by the flash 12 and relays the sensed intensity of the light to a digital signal processor (DSP) 507 of FIG. 3 via a micro-controller 512 of FIG. 3. The remote receiver 41 receives command signals, for example, a photographing command signal, from a remote controller (not shown) and relays the command signals to the DSP 507 via the micro-controller 512.

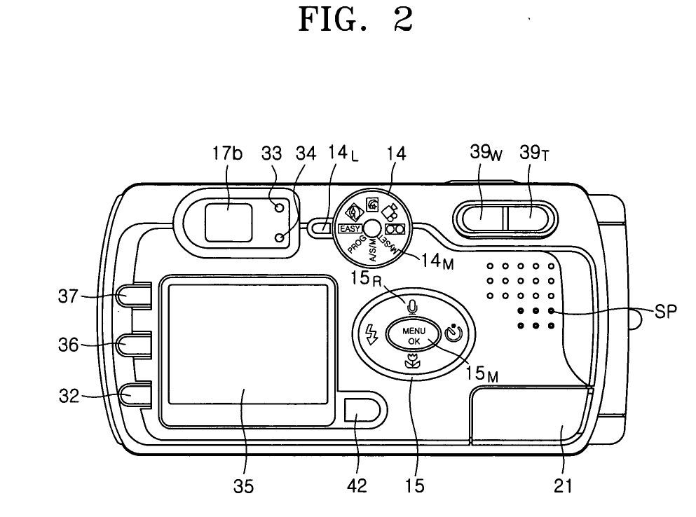

Referring to FIG. 2, the back of the digital camera 1 according to the present invention includes a mode dial 14, functional buttons 15, a manual focus/delete button 36, a manual adjust/reproduce button 37, a reproduction mode button 42, a speaker SP, a monitor button 32, an automatic focusing lamp 33, a viewfinder 17b, a flash standby lamp 34, a color LCD panel 35, a wide-angle zoom button 39_{w}, a telephoto zoom button 39_{T}, and an external interface unit 21.

The mode dial 14 is used for selecting any one of the operating modes of the digital camera 1 such as a simple photographing mode, a program photographing mode, a character photographing mode, a night view photographing mode, a manual photographing mode, a moving-image photographing mode, a user setting mode 14_{M}, and a voice recording mode.

The user setting mode 14_{M} is an operating mode in which the user selects the photograph-taking settings for each photographing mode. The voice recording mode is for recording only sounds, e.g. the voice of the user.

The functional buttons 15 are used for operating specific functions of the digital camera 1. The functional buttons 15 are also used as control buttons to manage the movement of an active cursor on the menu screen of the color LCD panel 35. For example, if the user presses a voice/memo/up button 15_{R}, a 10 second recording is possible upon consecutive photographing. Also, after a user has pressed a menu/select-confirm button 15_{M}, the voice/memo/up button 15_{R} can be used to move the cursor up.

The manual focus/delete button 36 is used for manual focusing or deleting in the photographing mode.

The manual adjust/reproduce button 37 is used for manual adjustment of specific conditions and for termination or reproduction in the reproducing mode. The reproduction mode button 42 is used for switching between the reproducing mode and a preview mode.

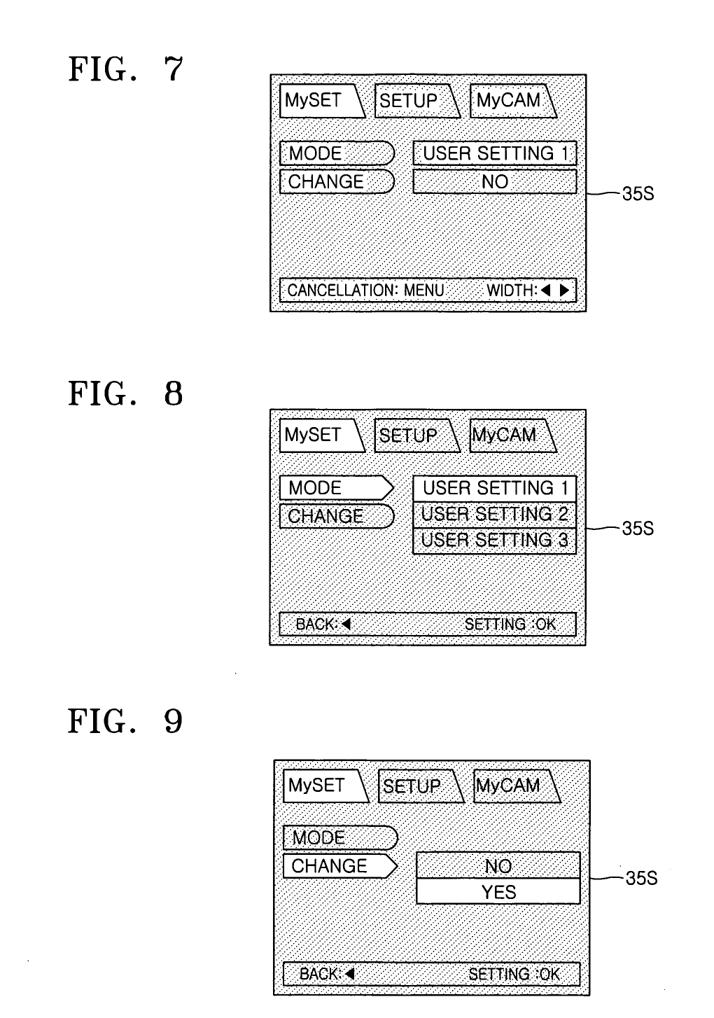

The monitor button 32 is used for controlling the operation of the color LCD panel 35. For example, in the photographing mode, when the user presses the monitor button 32, an image and photographing information are displayed on the color LCD panel 35. When the user presses the monitor button 32 again, the color LCD panel 35 is turned off. In the reproducing mode, when the user presses the monitor button 32 while an image file is being reproduced, photographing information about the image file is displayed on the color LCD panel 35 (See FIG. 7). When the user presses the monitor button 32 again, only pure images are displayed.

The automatic focusing lamp 33 operates when a focus of a lens is well adjusted. The flash standby lamp 34 operates when the flash 12 of FIG. 1 is in a standby mode. A mode indicating lamp 14_{L} indicates a selection mode of the mode dial 14.

FIG. 3 is a schematic diagram of the entire configuration of the digital camera 1 of FIG. 1. The entire configuration and operation of the digital camera 1 of FIG. 1 will now be described with reference to FIGS. 1 through 3.

A transparent barrier 13 preventing foreign matter from adhering to an optical system (OPS) is opened or closed by a barrier motor M_{B}. The OPS including the lens unit 20 and a filter unit optically processes light. The lens unit 20 of the OPS includes a zoom lens, a focal lens, and a compensation lens.

When the user presses the wide-angle zoom button 39_{W} or the telephoto zoom button 39_{T} included in a user input portion (INP), a signal corresponding to the wide-angle zoom button 39_{W} or the telephoto zoom button 39_{T} is relayed to the micro-controller 512. The micro-controller 512 controls a lens driver 510, thereby running a zoom motor M_{Z}, which in turn, moves the zoom lens. In other words, when the user presses the wide-angle zoom button 39_{W}, the focal length of the zoom lens becomes short, thereby widening the angle of view. When the user presses the telephoto zoom button 39_{T}, the focal length of the zoom lens becomes long, thereby narrowing the angle of view. Since the position of the focal lens is adjusted in a state where the position of the zoom lens is set, the angle of view is hardly affected by the position of the focal lens.

In the automatic focusing mode, a main controller built into the DSP 507 controls the lens driver 510 through the micro-controller 512, thereby driving a focus motor M_{F}. Accordingly, when the focus lens is moved, the position of the focal lens, for example, a number of driving steps of the focus motor MF, having a largest high frequency component of an image signal is set.

The compensation lens (not shown) in the lens unit 20 of the OPS is not separately operated because the compensation lens compensates for the entire refractive index. Reference numeral M_{A} indicates a motor for driving an aperture (not shown).

An optical low-pass filter (not shown) included in the filter unit of the OPS eliminates high frequency optical noise. An infrared cut filter (not shown) included in the filter unit of the OPS blocks the infrared component of incident light.

A photoelectric conversion unit (OEC) of a charge coupled device or a complementary metal oxide (CMOS) semiconductor converts light from the OPS into an analog electrical signal. Here, the DSP 507 controls a timing circuit 502 to control the operations of the OEC and a correlation-double-sampler-and-analog-to-digital converter (CDS-ADC) 501. The CDS-ADC 501 processes an analog signal from the OEC, eliminates high frequency noise, adjusts amplitude, and then converts the analog signal into a digital signal.

A real-time clock (RTC) 503 provides time information to the DSP 507. The DSP 507 processes the digital signal from the CDS-ADC 501 and generates a digital image signal composed of luminance and chromaticity values. The digital image signal from the DSP 507 is input to an LCD driver 514, thereby displaying an image on the color LCD panel 35.

The digital image signal from the DSP 507 can be transmitted as serial communications via a universal serial bus (USB) connector 21a or via an RS232C interface 508 and an RS232C connector 21b. The digital image signal from the DSP 507 can also be transmitted as a video signal via a video filter 509 and a video output unit 21c.

A light emitting portion (LAMP) is operated by the micro-controller 512 in response to a control signal generated by the DSP 507 including the main controller. The light emitting portion (LAMP) includes the self-timer lamp 11, the automatic focusing lamp 33, the mode indicating lamp 14_{L}, and the flash standby lamp 34. The INP includes the shutter button 13, the mode dial 14, the functional buttons 15, the monitor button 32, the manual focus/delete button 36, the manual adjust/reproduce button 37, the wide-angle zoom button 39_{W}, the telephoto zoom button 39_{T}, and the reproduction mode button 42.

A dynamic random-access memory (DRAM) 504 temporarily stores a digital image signal from the DSP 507. An electrically erasable and programmable read-only memory (EEPROM) 505 stores programs and setting data. A user's memory card is inserted or removed in a memory card interface (MCI) 506.

An audio processor 513 can relay sound from the microphone MIC to the DSP 507 or to the speaker SP. In addition, the audio processor 513 can output an audio signal from the DSP 507 to the speaker SP. The micro-controller 512 controls the operation of a flash controller 511 in response to a signal from the flash light intensity sensor (FS) 19, thereby driving the flash 12.

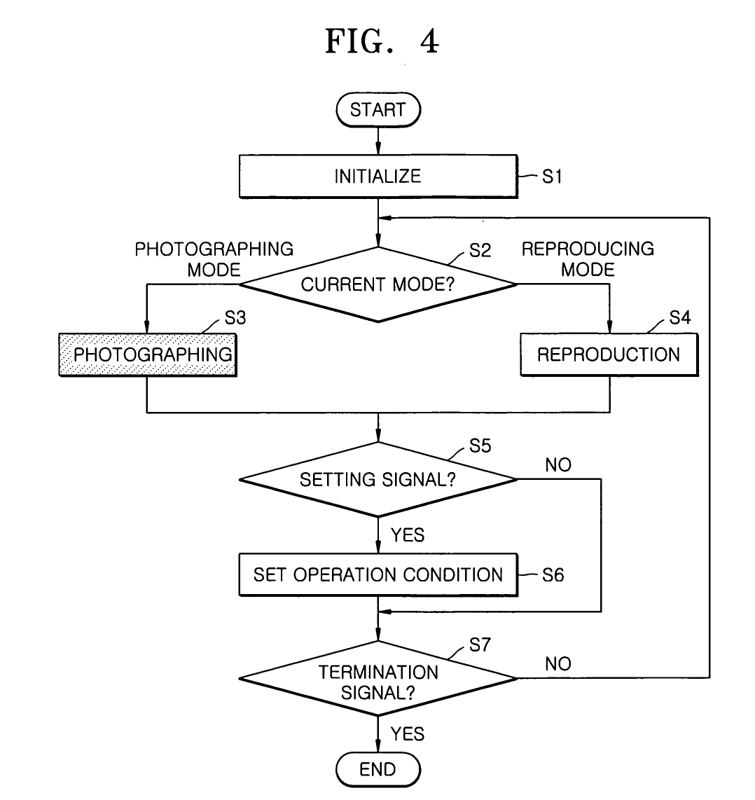

FIG. 4 is a flowchart illustrating a main program of the DSP 507 illustrated in FIG. 3. The main program of the DSP 507 will be now described with reference to FIGS. 1 through 4.

When power is applied to the digital camera 1, the DSP 507 is initialized (S1). After the initialization (S1), the DSP 507 enters a current mode (S2). If the current mode is the reproducing mode the DSP 507 controls reproduction (S4). If the current mode is the photographing mode, the DSP 507 controls photographing (S3).

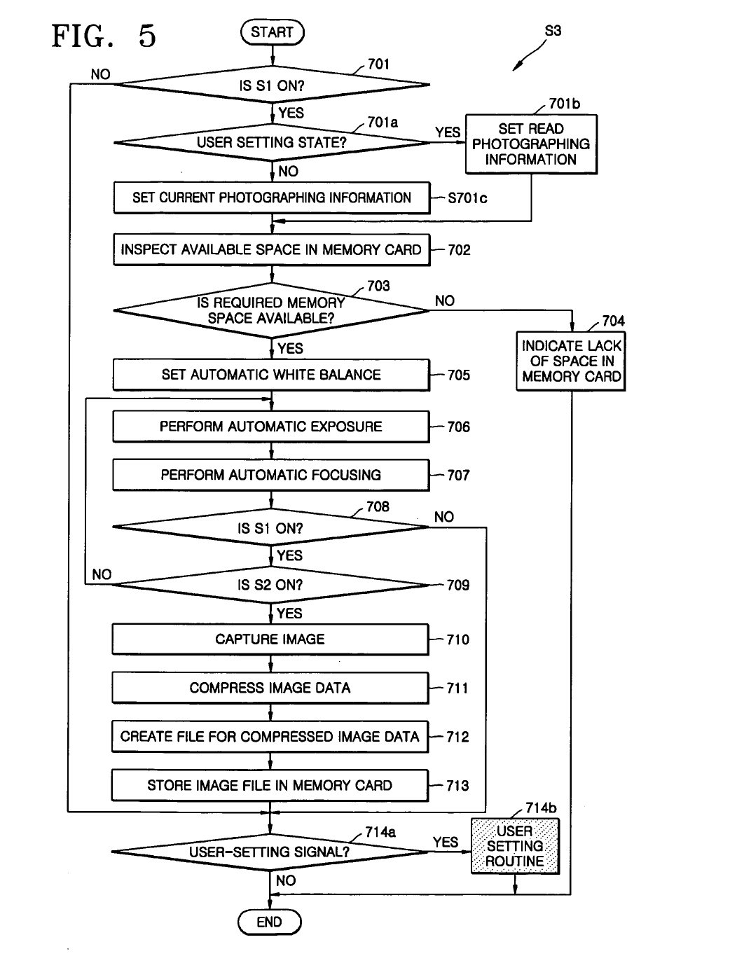

One of the photographing modes is a user setting mode 14_{M}. The user setting mode 14_{M} is selected by manipulating the mode dial 14. If the current photographing mode is the user setting mode 14_{M}, the DSP 507 performs the user setting routine (714b of FIG. 5).

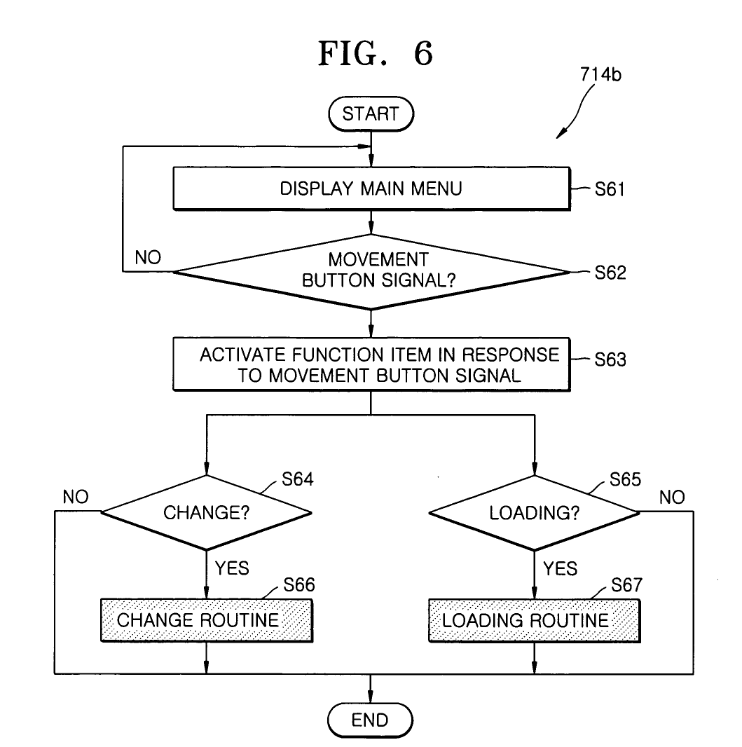

The user setting routine (operation 714b) includes a change routine for changing photographing information (S66 of FIG. 6) and a loading routine for loading photographing information (S67 of FIG. 6). In the change routine (S66), the main controller included in the DSP 507 stores image data of a new image file created as a result of a recent photographing operation, photographing information of the image file, and a guidance voice according to the user's choice. In the loading routine (S67), the image, photographing information, and guidance voice of a selected setting item are reproduced. The photographing information, for example, may be photographing settings such as an image resolution, an aperture value, a shutter speed, a sensitivity, a white balance or a flash setting.

Accordingly, even long after storing photographing conditions using the change routine of the user setting mode, the user can immediately determine what photographing conditions the user stored and whether to reuse the photographing conditions. The change routine (S66) and the loading routine (S67) will be described later in detail with reference to FIGS. 5 through 13.

When the photographing operation is performed in the user setting mode 14_{M}, the main controller included in the DSP 507 sets the photographing information of the image selected in the loading routine (S67) and performs the photographing operation according to the set photographing information.

While performing the photographing operation (S3) or the reproduction operation (S4), if a signal indicating that operation conditions of the digital camera 1 should be set is received from the INP (S5), the DSP 507 sets operation conditions of various modes in response to a command signal generated by the user (S6).

The above operations are repeated until a termination signal is input from an external source (S7).

The photographing program (S3) of FIG. 4 will now be described with reference to FIGS. 1 through 3 and 5. The shutter button 13 included in the INP has two levels. When the user presses the shutter button 13 to a first level, a first level signal S1 from the shutter button 13 is turned on. When the user presses the shutter button 13 to a second level, a second level signal S2 from the shutter button 13 is turned on.

The DSP 507 determines whether the first level signal S1 from the shutter button 13 is on (operation 701). If the first level signal S1 from the shutter button 13 is not on, the DSP 507 decides whether to perform the user setting routine. In operation 714a, if the DSP 507 determines that a user-setting signal is on, it performs the user setting routine (operation 714b). The user-setting signal is generated when the current mode is the user setting mode and the menu/select-confirm button 15_{M} is pressed.

In operation 701, if the first level signal S1 from the shutter button 13 is on, the DSP 507 determines whether the current mode is the user setting mode (operation 701a). If the current mode is the user setting mode, the DSP 507 performs operation 701(b), thereby setting the photographing information selected and read in the user setting routine (operation 714b). If the current mode is not the user setting mode, the DSP 507 sets current photographing information (operation 701c). The photographing information may be reset by operating the functional buttons 15 including the menu/select-confirm button 15_{M}.

The DSP 507 inspects the remaining capacity of the memory card (operation 702) and determines whether the memory card has enough capacity to store a digital image signal (operation 703). If the memory card does not have enough storage capacity, the DSP 507 indicates the lack of capacity of the memory card (operation 704). If the memory card has enough storage capacity, the following operations are performed.

The DSP 507 performs automatic white balancing (AWB) and sets parameters related to the AWB according to the photographing information read in operation 701a (operation 705). Then, the DSP 507 performs an automatic exposure (AE) mode according to the photographing information read in operation 701a calculates the exposure by measuring incident luminance, and drives the aperture driving motor M_{A} according to the calculated exposure (operation 706). The DSP 507 performs automatic focusing according to the photographing information read in operation 701a and drives the focal lens (operation 707).

The DSP 507 determines whether the first level signal S1 from the shutter button 13 is on (operation 708).

If the first level signal S1 from the shutter button 13 is not on, the DSP 507 performs operation 714a for determining whether a user-setting signal is on. In operation 714a, if the DSP 507 determines that the user-setting signal is on, it performs the user setting routine (operation 714b).

If the DSP determines that the first level signal S1 from the shutter button 13 is on, the following operations are performed. The DSP 507 determines whether the second level signal S2 is on (operation 709). When the second level signal S2 is not on, it means that the user did not press the shutter button 13 to the second level to take a photograph. Then, the DSP 507 goes back to operation 706 and performs subsequent operations.

When the second level signal S2 is on, it means that the user pressed the shutter button 13 to the second level. Thus, the DSP 507 captures an image (operation 710). In other words, the DSP 507 controls the timing circuit 502 to operate the OEC and the CDS-ADC 501. The DSP 507 compresses image data (operation 711) and creates a file for the compressed image (operation 712). The DSP 507 transmits the file for the compressed image to the user's memory card via the memory card interface 506 (operation 713).

Next, the DSP 507 determines whether to perform the user setting routine (operation 714b). In operation 714a, if the DSP 507 determines that user-setting signal is on, i.e. the current mode is the user setting mode and the menu/select-confirm button 15_{M} has been pressed, it performs the user setting routine (operation 714b).

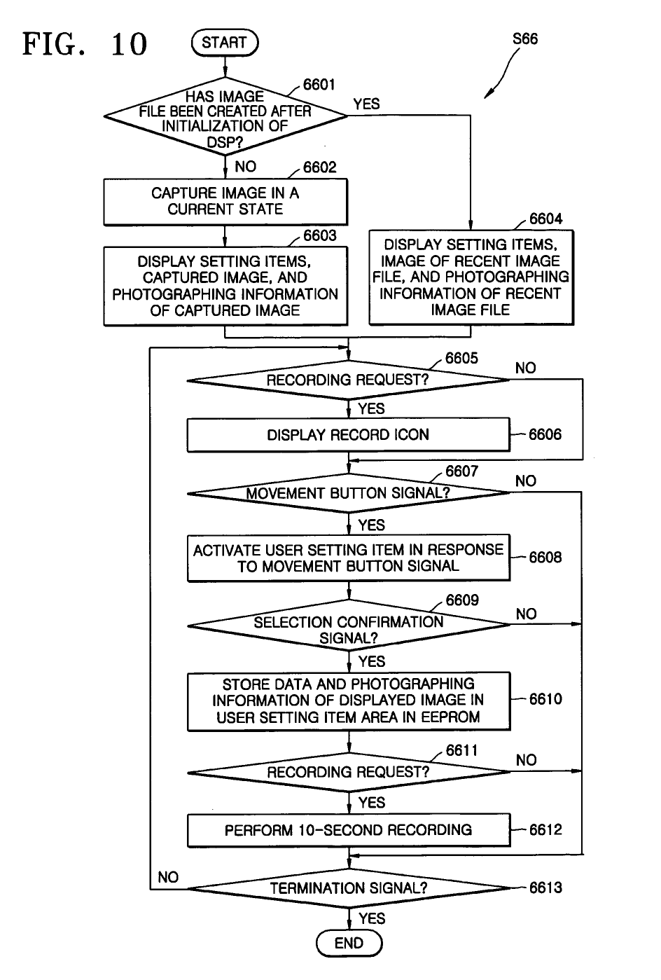

FIG. 6 is a flowchart illustrating an embodiment of the user setting routine (operation 714b) of FIG. 5. FIG. 7 is a screen (35S) displayed on the color LCD panel 35 of FIG. 2 as a result of performing operation S61 of FIG. 6, according to an embodiment of the present invention. FIG. 8 is a screen displayed on the color LCD panel 35 when the loading routine is selected as a result of performing operation S63 of FIG. 6, according to an embodiment of the present invention. FIG. 9 is a screen displayed on the color LCD panel 35 when the change routine is selected as a result of performing operation S63 of FIG. 6 according to an embodiment of the present invention. The user setting routine (operation 714b) program of FIG. 5 will now be described with reference to FIGS. 6 through 9.

The DSP 507 of FIG. 3 displays a main menu for performing the user setting mode (S61, see FIG. 7). If the functional buttons 15 of FIG. 2 generate a movement button signal (S62), the DSP 507 activates a function item while moving the active cursor in response to the movement button signal (S63, see FIGS. 8 and 9).

While the screen of FIG. 9 is displayed, if the DSP 507 receives a change signal generated by the menu/select-confirm button 15_{M} (S64), it performs the change routine (S66). While the screen of FIG. 8 is displayed, if the DSP 507 receives a loading signal generated by the menu/select-confirm button 15_{M} (S65), it performs the loading routine (S67).

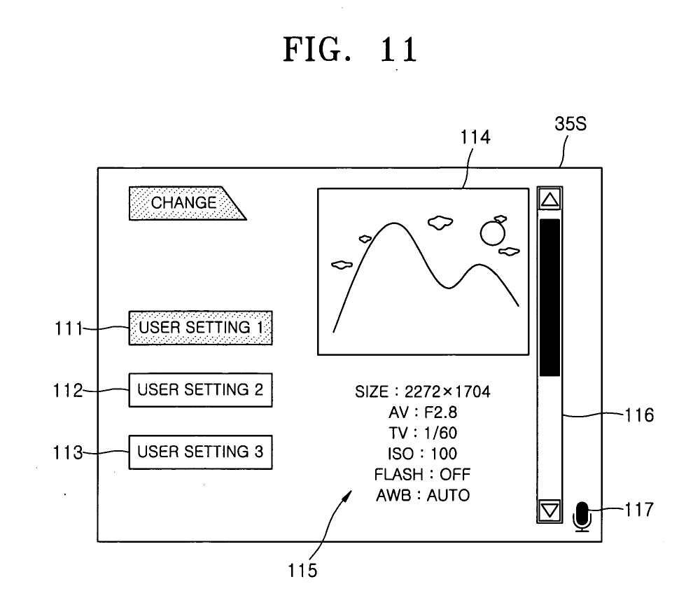

FIG. 10 is a flowchart illustrating an embodiment of the change routine (S67) program of FIG. 6. FIG. 11 is a screen displayed on the color LCD panel 35 of FIG. 2 as a result of performing operation 6606 of FIG. 10, according to an embodiment of the present invention. The change routine (S66) program will now be described with reference to FIGS. 10 and 11.

The DSP 507 of FIG. 3 determines whether a new image file has been created as a result of a photographing operation after the DSP 507 was initialized (operation 6601). If an image file has been created after the initialization of the DSP 507 (S1), the DSP 507 displays setting items 111 through 113, an image of a recent image file 114, photographing information of the recent image file 115, and a scroll-bar 116 on a screen 35S of the color LCD panel 35 of FIG. 2 (operation 6604).

If the image file has not been created after the initialization of the DSP 507 (S1), the DSP 507 captures the image 114 in a current state (operation 6602) and displays the setting items 111 through 113 of FIG. 11, the captured image 114, photographing information of the captured image 115, and the scroll-bar on the screen 35S of the color LCD panel 35 of FIG. 2 (operation 6603). In this case, since the captured image has not been created by the user, data of the captured image is not stored in a storage medium such as a memory card.

When the user generates a recording request signal by pressing the voice/memo/up button 15_{R} of FIG. 2 (operation 6605), the DSP 507 displays a record icon 117 of FIG. 11 on the screen 35S of the color LCD panel 35 (operation 6606). When the movement button signal is generated by the functional buttons 15 of FIG. 2, the DSP 507 activates the user setting item 111, 112, or 113 while moving the active cursor in response to the movement button signal (operation 6608).

When the user generates a selection confirmation signal by pressing the menu/select-confirm button 15_{M} of FIG. 2 (operation 6609), the DSP 507 stores data and photographing information of a displayed image in a user setting item area in the EEPROM 505 of FIG. 3 (operation 6610).

In operation 6605, if the recording request signal was generated (operation 6611), the DSP 507 controls the audio processor 513 of FIG. 3 to perform recording for a predetermined period of time, for example, 10 seconds (operation 6612). Operations 6605 through 6612 are repeated until the termination signal is received (operation 6613).

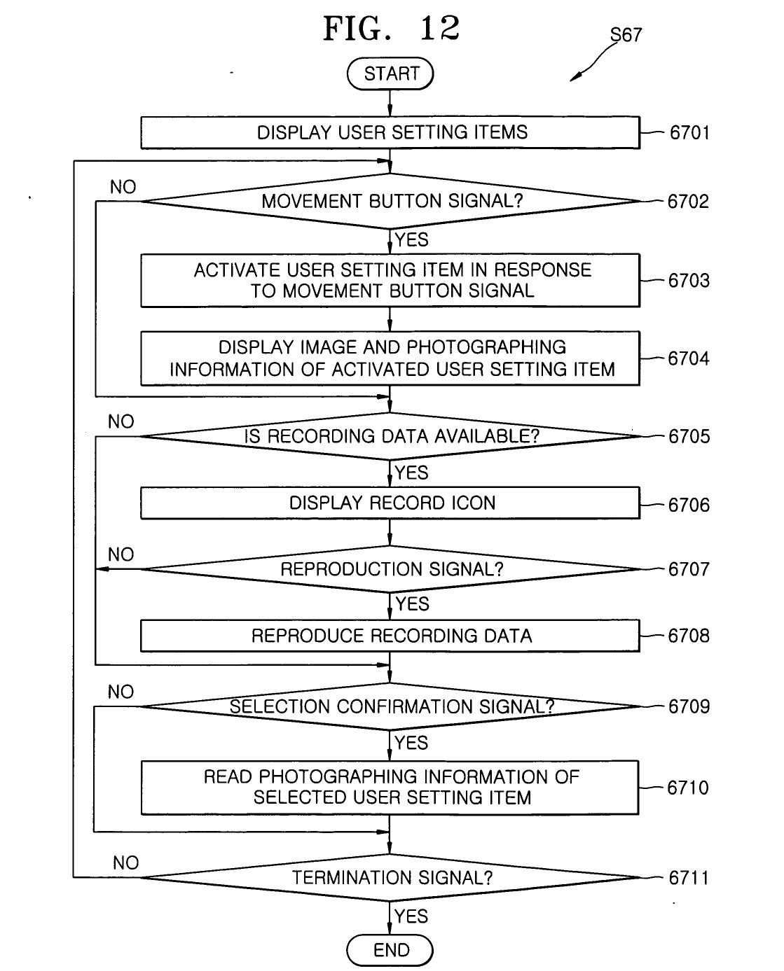

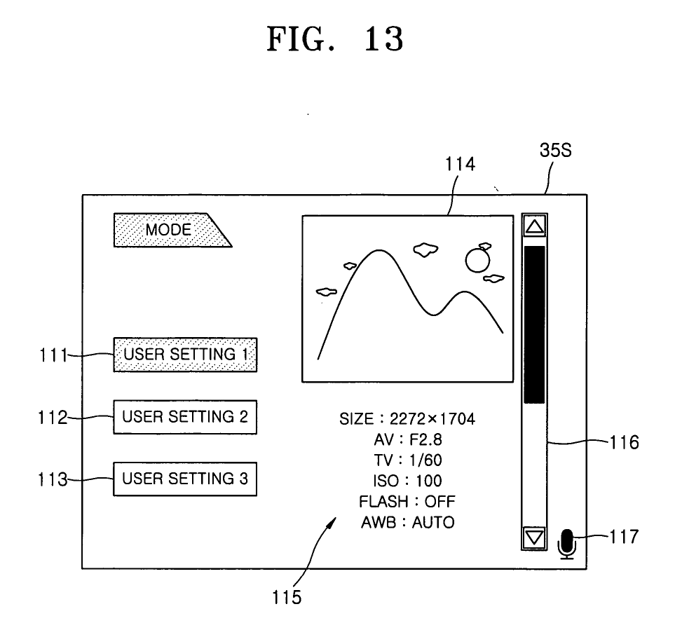

FIG. 12 is a flowchart illustrating an embodiment of the loading routine (S67) of FIG. 6. FIG. 13 is a screen displayed on the screen 35S of the color LCD panel 35 of FIG. 2 as a result of performing operation 6706 of FIG. 12, according to an embodiment of the present invention. The loading routine (S67) program of FIG. 6 will now be described with reference to FIGS. 12 and 13.

The DSP 507 displays the setting items 111 through 113 of FIG. 13 on the screen 35S of the color LCD panel 35 of FIG. 2 (operation 6701). When the movement button signal is generated by the functional buttons 15 of FIG. 2, the DSP 507 activates the user setting item 111, 112, or 113 while moving the active cursor in response to the movement button signal (operation 6703).

The DSP 507 reads the image 114 of FIG. 13 and the photographing information 115 of FIG. 13 of the activated user setting item 111, 112, or 113 from the user setting item area of the EEPROM 505 of FIG. 3 and displays the image 114 and the photographing information 115 on the screen 35S of the color LCD panel 35 together with the scroll-bar 116 of FIG. 13 (operation 6704).

If recording data is present in the activated user setting item 111, 112, or 113 (operation 6705), the DSP 507 displays the record icon 117 of FIG. 13 on the screen 35S of the color LCD panel 35 (operation 6706). When the user generates a reproduction signal by pressing the menu/select-confirm button 15_{M} of FIG. 2 (operation 6707), the DSP 507 controls the audio processor 513 of FIG. 3 to reproduce the recording data (operation 6708).

When the user generates the selection confirmation signal by pressing the menu/select-confirm button 15_{M} of FIG. 2 (operation 6709), the DSP 507 reads the photographing information of a selected user setting item 111, 112, or 113 (operation 6710). Accordingly, the read photographing information will be used later for the photographing operation in the user setting state (See operations 701a and 701b of FIG. 5). Operations 6702 through 6710 are repeated until the termination signal is received (operation 6711).

As described above, according to a digital photographing apparatus and a method of controlling the same, an image of image data stored in a change routine of a user setting mode is displayed in a loading routine of the user setting mode. Accordingly, even long after a user stored a photographing condition in the change routine of the user setting mode, the user can immediately identify what photographing condition the user stored and determine whether the photographing condition can be reused.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of controlling a digital photographing apparatus capable of storing and reloading photographing information of a previously captured image, the method comprising:
initializing a digital processor;
determining whether the apparatus is in a user setting mode;
determining whether a photograph has been taken since the digital processor was initialized;
if a photograph has been taken since the digital processor was initialized, displaying on a display screen a image representing a subject of a most recent photograph;
if a photograph has not been taken since the digital processor was initialized, taking a photograph according to a current photographing information and displaying on the display screen an image representing a subject of the photograph;
detecting a user input;
in response to the user input, storing an image file for the subject in a setting storage medium, wherein the image file is associated with a user setting and includes both image data and related photographing information;
detecting a user's selection of the user setting; and
in response to the user's selection of a user setting, setting a photographing condition for taking a subsequent photograph, wherein the photographing condition is based upon the photographing information within the image file associated with the selected user setting.

2. The method of claim 1, further comprising:
detecting a third user input;
in response to the third user input, retrieving the image file and displaying the image file on the display screen.

3. The method of claim 1, further comprising:
detecting a second user input;
in response to the second user input, capturing audio data and storing the audio data in the image file.

4. The method of claim 1, further comprising:
detecting a second user input;
in response to the second user input, capturing audio data and storing the audio data in the image file;
detecting a third user input; and
in response to the third user input, reproducing the audio data in the image file.

5. The method of claim 4, wherein the audio data comprises guidance information regarding the image or the photographing information.

5. The method of claim 2, wherein the image and photographing information are concurrently displayed on the display screen.

6. The method of claim 1, wherein the selected user setting is one of a plurality of user settings previously input by the user, further comprising:
detecting a third user input signal;
in response to the third user input signal, altering the appearance of one of the plurality of user settings;
detecting a fourth user input signal;
in response to the fourth user input signal, associating the altered user setting with the image and photographing information.

7. The method of claim 6, wherein the plurality of user settings comprises a first user setting, a second user setting, and a third user setting.

8. The method of claim 1, wherein the user selects a user setting by manipulating a directional button and pressing a confirmation button.

9. The method of claim 1, wherein the photographing information comprises photographing settings selected from the group consisting of an image resolution, an aperture value, a shutter speed, a sensitivity, a white balance and a flash setting.

10. The method of claim 1, further comprising:
taking the subsequent photograph;
storing image data representing the subsequent photograph in an image file in an image storage medium.

11. A method of controlling a digital photographing apparatus capable of storing and reloading photographing information of a previously captured image, the method comprising:
detecting a first-level photographing signal;
in response to the first-level photographing signal, determining whether the apparatus is in a user setting mode, applying photographing information to the apparatus, and capturing an image of a photographing subject in response to detecting a second-level photographing signal, wherein the photographing information comprises preset photographing information if the apparatus is in a user setting mode and comprises current photographing information if the apparatus is not in a user setting mode;
detecting a user setting signal;
in response to a user setting signal, performing a user setting routine comprising a first procedure in which, upon detection of a first signal, a current image file containing image data and associated photographing information for a current image is linked to a user setting icon and a second procedure in which, upon detection of a second signal, a user setting icon already linked to a previous image file containing a previous image and its associated photographing information is selected in order to apply the photographing information of the previous image file during a subsequent photographing operation.

12. The method of claim 11, wherein the photographing information comprises photographing settings selected from the group consisting of an image resolution, an aperture value, a shutter speed, a sensitivity, a white balance and a flash setting.

13. The method of claim 12, wherein the image file is stored in an electrically erasable and programmable read-only memory.

14. The method of claim 12, wherein the user input is generated by a user's manipulation of at least one button.

15. The method of claim 12, wherein the image captured in response to the detection of the second-level photographing signal is stored in a captured-image file in a memory storage medium.

16. A digital photographing apparatus, the apparatus comprising:
an optical system including a lens unit that receives light from a subject to be photographed by the apparatus;
a mode selection device capable of setting at least a user setting mode;
a digital processor in communication with the optical system for driving the lens unit according to a photographing setting, wherein the digital processor receives signals representing the light received by the optical system and generates a signal representing an image of the subject;
a display screen capable of displaying the image;
at least one user input button for selecting an image to associate with a user setting icon in a user setting mode;
at least one storage medium for storing an image file containing image data and the photographing information for the image, wherein the image file is associated with the user setting icon, and wherein the digital processor is capable of retrieving the image file and loading the photographing information for use during a subsequent photographing operation.

17. The apparatus of claim 16, further comprising a photoelectric converter that converts light received by the optical system into electric analog signals and a correlation double sampler and analog-to-digital converter that processes the analog signals output from the photoelectric converter, removes high frequency noise from the signals, alters the bandwidth of the signals, and converts the analog signals into digital signals, which are processed by the digital processor.

18. The apparatus of 16, further comprising a microphone and a speaker.

19. The apparatus of 16, wherein the display screen comprises a color liquid crystal display.

20. The apparatus of 16, wherein the photographing information comprises photographing settings selected from the group consisting of an image resolution, an aperture value, a shutter speed, a sensitivity, a white balance and a flash setting.
